(19) United States
(12) Patent Application Publication
(10) Pub. No.: US 2007/0260341 A1
(43) Pub. Date: Nov. 8, 2007

(54) CORRECTING APPARATUS FOR WAFER TRANSPORT EQUIPMENT AND CORRECTING METHOD FOR WAFER TRANSPORT EQUIPMENT

(76) Inventors: Chan-Tsun Wu, Hsinchu City (TW); Peter Lin, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,824

(22) Filed: Oct. 4, 2006

(30) Foreign Application Priority Data
May 5, 2006 (TW) 95116006

(51) Int. Cl. G06F 19/00

(52) U.S. Cl. 700/95

(57) ABSTRACT

A correcting apparatus for wafer transport equipment is provided. The correcting apparatus includes a reflective component, an image capture module, an image processing module and a screen. The reflective component is disposed near a wafer carrying device to reflect an image of the wafer carrying device to the image capture module. The image capture module is disposed in the optical path of the reflected light of the reflective component to capture the image in the wafer carrying device. The image capture module is coupled to the image processing module. When a conveyer stretches into the wafer carrying device, the image processing module analyzes the image captured by the image capture module to determine whether the location of the conveyer is correct or not. The location of the conveyer is accurately and immediately adjusted according to the result of the analysis.

### CROSS-REFERENCE TO RELATED APPLICATION

This application claims the priority benefit of Taiwan application serial no. 95116006, filed on May 5, 2006. All disclosure of the Taiwan application is incorporated herein by reference.

### BACKGROUND OF THE INVENTION

1. Field of Invention

The present invention relates to a correcting apparatus for wafer transport equipment. More particularly, the present invention relates to a correcting apparatus for wafer transport equipment and a correcting method for wafer transport equipment via a computer.

2. Description of Related Art

In the workshop for manufacturing semiconductor wafers, a precision mechanical arm is usually used to transport wafers. Before using the mechanical arm to transport wafers, it is necessary to correct the location of the mechanical arm to avoid damage to the wafers due to the improper location of the mechanical arm. For various mechanical arms provided at present, the locations of most mechanical arms are corrected by eyes. The above correcting method often results in an incorrect location of the mechanical arm due to the factors such as different viewing angles of the operators and subjective judgment from different operators. Thus, the mechanical arm may scrape or crack the wafer when picking up or placing the wafer.

FIG. 1 is a schematic view of a plurality of mechanical arms stretching into a front opening unified pod (FOUP) at the same time in a conventional art. Referring to FIG. 1, mechanical arms 111˜115 of a mechanical arm table 110 are used to transport wafers 121˜125 placed in accommodating slots 131˜135 of an FOUP 130, and the FOUP 130 is disposed on a carrying port 140. As the mechanical arm table 110 has a plurality of mechanical arms 111˜115, and the operator has to determine whether the location of each mechanical arm 111˜115 is correct or not in sequence when correcting the mechanical arms 111˜115, the correcting process is time-consuming. In addition, in a plurality of mechanical arms 111˜115, it is difficult for the operator to recognize the offset in the height of even one mechanical arm (for example, the mechanical arm 113). As such, when stretching into the FOUP 130, the mechanical arm 113 may touch the wafer disposed on the accommodating slot 132, thus causing damage to the wafer 122.

Therefore, the method for correcting the location of the mechanical arm by eyes in the conventional art cannot accurately and efficiently adjust the location of the mechanical arm, especially the locations of a plurality of mechanical arms.

### SUMMARY OF THE INVENTION

Accordingly, an objective of the present invention is to provide a correcting apparatus for wafer transport equipment, which can accurately correct the wafer transport equipment so as to avoid damage to a wafer when picking up and placing the wafer.

Another objective of the present invention is to provide a correcting method for wafer transport equipment to accurately correct the wafer transport equipment, so as to pick up and place a wafer successfully.

In order to achieve the above or other objectives, the present invention provides a correcting apparatus for wafer transport equipment to correct a wafer transport equipment. The wafer transport equipment comprises a conveyer for removing a plurality of wafers from or placing a plurality of wafers into a plurality of accommodating slots of the wafer carrying device. The correcting apparatus for wafer transport equipment comprises a reflective component, an image capture module, an image processing module and a screen. The reflective component is disposed near the wafer carrying device. The image capture module is disposed in the optical path of the reflected light of the reflective component. The reflective component reflects an image in the wafer carrying device to the image capture module. The image capture module captures the image in the wafer carrying device. The image processing module is coupled to the image capture module. When the conveyer stretches into the wafer carrying device, the image processing module analyzes the image captured by the image capture module to determine whether the location of the conveyer is correct or not. The screen is coupled to the image capture module to display the image captured by the image capture module.

In an embodiment of the present invention, the conveyer in the above-mentioned wafer transport equipment comprises at least one mechanical arm. The image processing module determines whether the location of each mechanical arm is correct or not when the mechanical arms stretch into the wafer carrying device.

In an embodiment of the present invention, the image capture module in the above-mentioned correcting apparatus for wafer transport equipment comprises a charge coupled device (CCD) or a complementary metal oxide semiconductor image sensor (CMOS image sensor).

The present invention provides a correcting method for wafer transport equipment, which adopts the above-mentioned correcting apparatus for wafer transport equipment to correct a wafer transport equipment. The wafer transport equipment comprises a conveyer for removing a plurality of wafers from or placing a plurality of wafers into a plurality of accommodating slots of a wafer carrying device. The correcting method for the wafer transport equipment comprises: first, making the conveyer of the wafer transport equipment stretch into the wafer carrying device; then, capturing an image in the wafer carrying device by the image capture module of the correcting apparatus for wafer transport equipment, and analyzing the image captured by the image capture module by the image processing module of the correcting apparatus for wafer transport equipment, so as to determine whether the location of the conveyer is correct or not; after that, adjusting the location of the conveyer according to the result of the determination.

In an embodiment of the present invention, the conveyer in the above-mentioned correcting method for wafer transport equipment comprises at least one mechanical arm. When a plurality of mechanical arms stretches into the wafer transport equipment, the mechanical arms first respectively stretch below one of a plurality of accommodating slots of the wafer transport equipment. The method for determining whether the location of the conveyer is correct or not comprises determining whether the distance between each mechanical arm and the accommodating slot thereon is correct or not.

In an embodiment of the present invention, in the above-mentioned correcting method for wafer transport equipment, the step of the method for adjusting the location of the conveyer according to the result of the determination comprises adjusting the mechanical arm with an incorrect distance between itself and the accommodating slot thereon to a proper location.

The present invention captures the image when the transport equipment stretches into the wafer carrying device by the image capture module, and corrects the transport equipment by the image processing module according to the captured image. Thus, the transport equipment can be accurately corrected to avoid damage to a wafer when being transported by the transport equipment.

In order to make the aforementioned and other objects, features and advantages of the present invention comprehensible, preferred embodiments accompanied with figures are described in detail below.

### BRIEF DESCRIPTION OF THE DRAWINGS

FIG. 1 is a schematic view of a plurality of mechanical arms stretching into the FOUP at the same time in the conventional art.

FIG. 2 is a schematic view of a wafer transport equipment and a correcting apparatus thereof according to an embodiment of the present invention.

FIG. 3 is a schematic view of the image captured by the image capture module in FIG. 2.

FIG. 4 is a flow chart of the correcting method for wafer transport equipment according to an embodiment of the present invention.

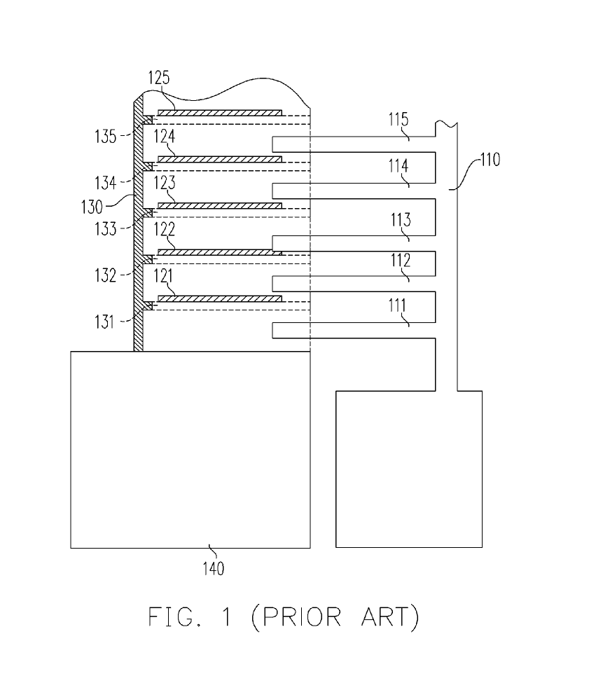

### DESCRIPTION OF EMBODIMENTS

In the semiconductor process, the conveyer is often used to move wafers to or from the wafer carrying device or various different tables, so as to perform different processes. As in the conventional art the mechanical arm is corrected by human eyes observing whether the location thereof is correct or not, it is likely to cause misjudgment. Therefore, the present invention provides a correcting apparatus for wafer transport equipment and a correcting method for wafer transport equipment to accurately correct the mechanical arm, thereby avoiding damage to the wafer when being transported. Here, the embodiments are used to illustrate the present invention instead of limiting the present invention. Some modifications can be made to the embodiments below by those skilled in the art according to the spirit of the present invention, which still belong to the scope of the present invention.

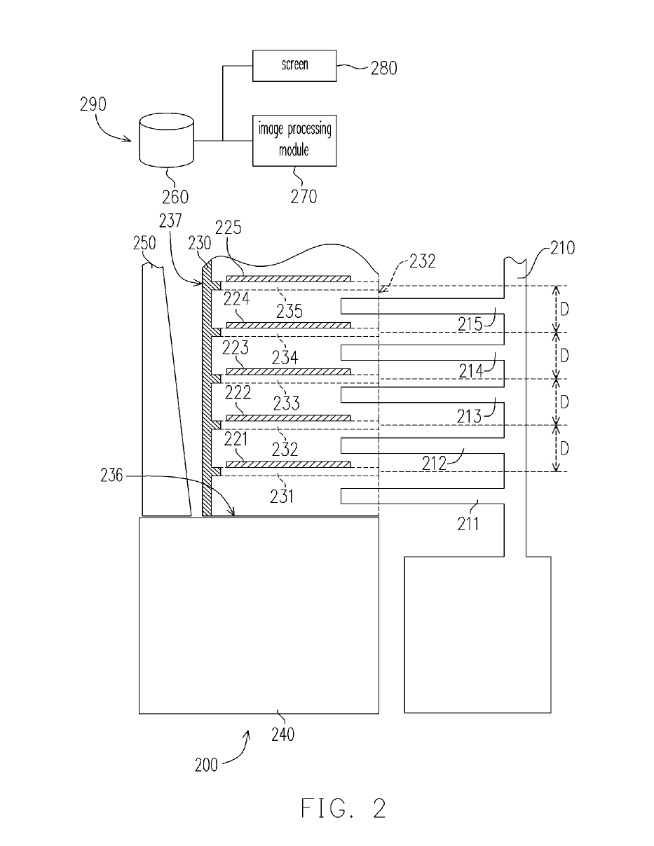

FIG. 2 is a schematic view of a wafer transport equipment and a correcting apparatus thereof according to an embodiment of the present invention. Referring to FIG. 2, a wafer transport equipment 200 comprises a conveyer 210 and a wafer carrying device 230. The wafer carrying device 230 has a plurality of accommodating slots (for example, accommodating slots 231˜235) to accommodate a plurality of wafers 221˜225. The conveyer 210 is used to remove the wafers 221˜225 from the accommodating slots 231˜235 or place the wafers 221˜225 into the accommodating slots 231˜235.

In view of the above, a correcting apparatus 290 for wafer transport equipment comprises a reflective component 250, an image capture module 260, an image processing module 270 and a screen 280. The reflective component 250 is disposed near the wafer carrying device 230. The image capture module 260 is disposed in the optical path of the reflected light of the reflective component 250. The image processing module 270 and the screen 280 are coupled to the image capture module 260. In addition, the reflective component 250 reflects an image in the wafer carrying device 230 to the image capture module 260. The image capture module 260 captures the image in the wafer carrying device 230. When the conveyer 210 stretches into the wafer carrying device 230, the image processing module 270 analyzes the image captured by the image capture module 260 to determine whether the location of the conveyer 210 is correct or not. The screen 280 displays the image captured by the image capture module 260.

In the present embodiment, the conveyer 210 comprises a plurality of mechanical arms, such as mechanical arms 211˜215. The wafer carrying device 230 is, for example, an FOUP. The wafer carrying device 230 has a top surface (not shown), an opposite bottom surface 236 and a plurality of side surfaces 237 connected to the top surface and the bottom surface 236. One of these side surfaces 237 has an opening 232, through which the mechanical arms 211˜215 of the conveyer 210 can stretch into the wafer carrying device 230, so as to remove the wafers 221 225 from or place the wafers 221 225 into the accommodating slots 231˜235 of the wafer carrying device 230. In addition, the accommodating slots 231˜235 of the wafer carrying device 230 are, for example, parallel to each other, and the distance between any two adjacent accommodating slots is the same. In the present embodiment, the reflective component 250 is, for example, a reflective mirror, which is disposed near one of the side surfaces 237 with no opening 232 of the wafer carrying device 230.

In view of the above, the wafer transport equipment 200 further comprises a carrying port 240. The wafer carrying device 230 is disposed on the carrying port 240. When the mechanical arm stretches into the wafer carrying device 230, the image capture module 260 transmits the captured image to the image processing module 270. The image processing module 270 then analyzes the image captured by the image capture module 260 to determine whether the locations of the mechanical arms 211˜215 are correct or not. In the present embodiment, the image capture module 260 is, for example, a CCD or a CMOS image sensor.

The screen 280 in the correcting apparatus 290 for wafer transport equipment in the present embodiment not only can be directly coupled to the image capture module 260, but also can be coupled to the image capture module 260 via the image processing module 270, such that the image capture module 260 outputs the captured image onto the screen 280. Thus, the operator obtains the locations of the mechanical arms 211˜215 via the image displayed by the screen 280.

In general, the wafer transport equipment is corrected before transporting a wafer, so as to avoid damage to the wafer due to the incorrect location of the wafer transport equipment. The above-mentioned correcting method for wafer transport equipment is introduced in detail below. Referring to FIGS. 2 to 4, FIG. 3 is a schematic view of the image captured by the image capture module in FIG. 2, and FIG. 4 is a flow chart of the correcting method for wafer transport equipment according to an embodiment of the present invention.

The correcting method for wafer transport equipment in the present embodiment comprises: first, as shown in Step S410, making the conveyer 210 of the wafer transport equipment 200 stretch into the wafer carrying device 230. In particular, in the present embodiment, the mechanical arms 211˜215 of the conveyer 210 stretch below the accommodating slots 231˜235 of the wafer carrying device 230 through the opening of the wafer carrying device 230.

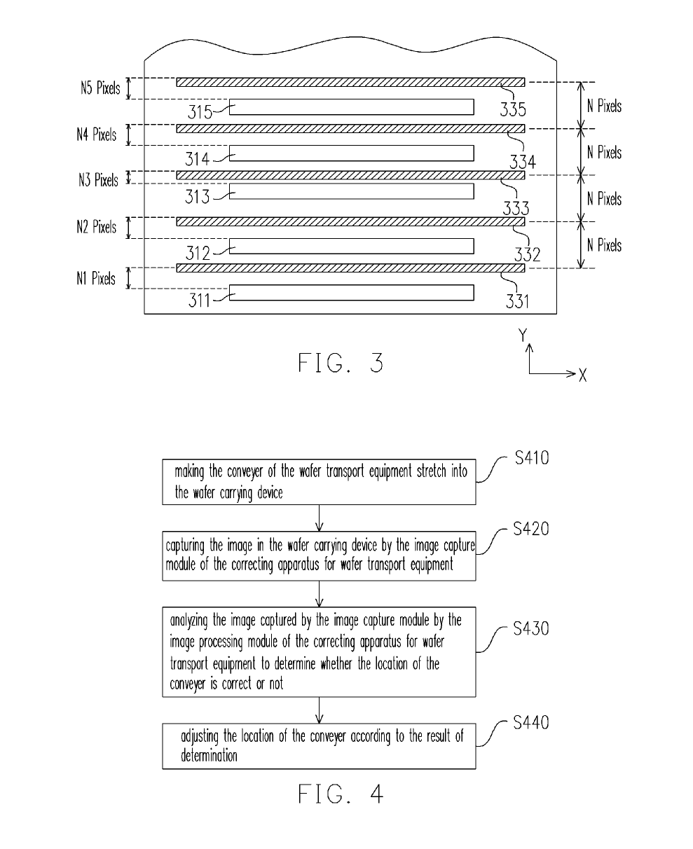

Next, as shown in Step S420, an image in the wafer carrying device 230 is captured by the image capture module 260 of the correcting apparatus 290 for wafer transport equipment. The image captured by the image capture module 260 is as shown in FIG. 3, which comprises images 331˜335 of the accommodating slots 231˜235 of the wafer carrying device 230 and images 311˜315 of a plurality of arms 211˜215 of the mechanical arm 210.

After that, as shown in Step S430, the image captured by the image capture module 260 is analyzed by the image processing module 270 of the correcting apparatus 290 for wafer transport equipment to determine whether the location of the conveyer 210 is correct or not. The method for determining whether the location of the conveyer 210 is correct or not is, for example, to determine whether the distances between the mechanical arms 211˜215 and the accommodating slots 231 235 thereon are correct or not.

More particularly, as the locations of the accommodating slots 231˜235 of the wafer carrying device 230 are fixed, and the spaces between adjacent accommodating slots 231˜235 are also fixed, the image processing module 270 can be used to calculate the corresponding pixel location of each accommodating slot 231˜235 in the image capture module 260, and the corresponding actual distance of each pixel can be calculated as D/N according to the distance D between adjacent accommodating slots and the pixel number N occupied in the image capture module 260. For example, if D=0 mm and N=0, the corresponding actual distance of each pixel is 1 mm. When the mechanical arms 211˜215 stretch below the corresponding accommodating slots 231˜235, the image processing module 270 can calculate whether the distance between each mechanical arm 211˜215 and each accommodating slot 231˜235 thereon is too far or too close according to the pixel numbers N1˜N5 between the images 311˜315 of the mechanical arms and the images 331˜335 of the accommodating slots thereon, thereby determining whether the location of each mechanical arm 211˜215 is correct or not.

After that, as shown in Step S440, the location of the conveyer 210 is adjusted according to the result of the determination. For example, when the image processing module 270 determines that the distance between the image 313 of the mechanical arm 213 and the image 333 of the accommodating slot 223 is too small, the mechanical arm 213 is adjusted downward to a proper location. On the contrary, when the image processing module 270 determines that the distance between the image 313 of the mechanical arm 213 and the image 333 of the accommodating slot 223 is too far, the mechanical arm 213 is adjusted upward to a proper location.

As the correcting method for wafer transport equipment in the present invention uses the image processing module 270 to determine whether the location of each mechanical arm 211˜215 is correct or not and adjusts the mechanical arm with an incorrect location, misjudgment due to human factors can be effectively avoided when the wafer transport equipment is corrected. In addition, the correcting method for wafer transport equipment in the present invention can determine whether the locations of a plurality of mechanical arms are correct or not at the same time and correct the mechanical arm with an incorrect location, thereby improving the correction efficiency.

It should be noted that the correcting method for wafer transport equipment in the present invention not only can correct the mechanical arm of the conveyer before transporting a wafer, but also can monitor the location of the mechanical arm while the conveyer is transporting a wafer and immediately correct the mechanical arm with an incorrect location, thereby preventing the mechanical arm from damaging the wafer.

In view of the above, the wafer transport equipment and the correcting method thereof in the present invention at least have the following advantages:

1.The present invention captures the image when the transport equipment stretches into the wafer carrying device by the image capture module, and corrects the transport equipment according to the captured image by the image processing module. Therefore, misjudgment due to human factors can be effectively avoided, thereby preventing damage to the wafer in the transport process.

2. As the present invention can determine whether the locations of a plurality of mechanical arms are correct or not at the same time, and correct the mechanical arm with an incorrect location, the time required for correcting the wafer transport equipment is shortened.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A correcting apparatus for wafer transport equipment, for correcting a wafer transport equipment, wherein the wafer transport equipment comprises a conveyer used to move a plurality of wafers from or into a plurality of accommodating slots of a wafer carrying device, the correcting apparatus for wafer transport equipment comprising:
a reflective component, disposed near the wafer carrying device;
an image capture module, disposed in the optical path of the reflected light of the reflective component, wherein the reflective component reflects an image in the wafer carrying device to the image capture module, and the image capture module captures the image in the wafer carrying device;
an image processing module, coupled to the image capture module, wherein when the conveyer stretches into the wafer carrying device, the image processing module analyzes the image captured by the image capture module to determine whether the location of the conveyer is correct or not; and
a screen, coupled to the image capture module to display the image captured by the image capture module.

2. The correcting apparatus for wafer transport equipment as claimed in claim 1, wherein the conveyer comprises at least one mechanical arm, and the image processing module determines whether the location of each of the mechanical arms when stretching into the wafer carrying device is correct or not.

3. The correcting apparatus for wafer transport equipment as claimed in claim 1, wherein the image capture module comprises a charge coupled device (CCD) or a complementary metal oxide semiconductor image sensor (CMOS image sensor).

4. A correcting method for wafer transport equipment, for correcting a wafer transport equipment by the correcting apparatus for wafer transport equipment as claimed in claim 1, wherein the wafer transport equipment comprises a conveyer used to move a plurality of wafer from or into a plurality of accommodating slots of a wafer carrying device, the correcting method for wafer transport equipment comprising:
making the conveyer of the wafer transport equipment stretch into the wafer carrying device;
capturing an image in the wafer carrying device by the image capture module of the correcting apparatus for wafer transport equipment;
analyzing the image captured by the image capture module by the image processing module of the correcting apparatus for wafer transport equipment to determine whether the location of the conveyer is correct or not; and
adjusting the location of the conveyer according to the result of the determination.

5. The correcting method for wafer transport equipment as claimed in claim 4, wherein the conveyer comprises at least one mechanical arm, and when stretching into the wafer carrying device, the mechanical arms first respectively stretch below one of the accommodating slots of the wafer carrying device, and the method for determining whether the location of the conveyer is correct or not comprises determining whether the distance between each mechanical arm and the accommodating slot thereon is correct or not.

6. The correcting method for wafer transport equipment as claimed in claim 5, wherein the method for adjusting the location of the conveyer according to the result of the determination comprises adjusting the mechanical arm with an incorrect distance between itself and the accommodating slot thereon to a proper location.
